(19) United States
(12) Patent Application Publication
(10) Pub. No.: US 2024/0356655 A1
(43) Pub. Date: Oct. 24, 2024

(54) OPTICAL RECEIVER AND OPTICAL RECEPTION METHOD

(71) Applicant: Mitsubishi Electric Corporation, Tokyo (JP)

(72) Inventors: Keisuke MATSUDA, Tokyo (JP); Tsuyoshi YOSHIDA, Tokyo (JP)

(73) Assignee: Mitsubishi Electric Corporation, Tokyo (JP)

(21) Appl. No.: 18/759,317

(22) Filed: Jun. 28, 2024

Related U.S. Application Data
(63) Continuation of application No. PCT/JP2022/005774, filed on Feb. 15, 2022.

(51) Int. Cl. H04B 10/61; H04J 14/02; H04L 7/00

(52) U.S. Cl. CPC H04B 10/6165; H04J 14/02; H04L 7/0075

(57) ABSTRACT

An optical receiver detects a clock phase of a signal in a time domain whose number of samples has been adjusted, estimates a clock frequency difference from a received signal using a detection value of the clock phase, determines a sampling phase for each FFT depending on an estimation value of the clock frequency difference, selects from a coefficient LUT a filter coefficient associated with a delay amount corresponding to the sampling phase, and multiplies a signal divided by a division unit with the selected filter coefficient.

### CROSS REFERENCE TO RELATED APPLICATIONS

This application is a Continuation of PCT International Application No. PCT/JP2022/005774, filed on Feb. 15, 2022, all of which is hereby expressly incorporated by reference into the present application.

### TECHNICAL FIELD

The present disclosure relates to an optical receiver and an optical reception method.

### BACKGROUND ART

In recent years, the bands of digital analog converters (hereinafter, simply referred to as DACs) and analog digital converters (hereinafter, simply referred to as ADCs) mounted on large-scale integrated circuits (hereinafter, referred to as a DSP-LSIs) that perform digital signal processing for optical communication of a digital coherent system continue broadening. The bands of optical parts that constitute optical transceivers also continue broadening in addition to DACs and ADCs mounted on DSP-LSIs, and the optical transceivers as a whole have larger capacity and broader bands.

To utilize a large-volume throughput and a wider band of an optical transceiver, a DSP-LSI multiplexes subcarriers. Consequently, one optical transceiver supports communication with a plurality of communicating parties and simultaneously supports signal accommodation of a plurality of services, so that the optical transceiver can contribute to efficiently constructing metro and access networks.

In this regard, although it is necessary to perform clock synchronization for a signal transmitted from each of the communicating parties to support communication with the plurality of communicating parties, a configuration of the optical transceiver is complicated in a case where a plurality of clock sources are mounted on the optical transceiver for communication with the plurality of communicating parties. By contrast with this, for example, a conventional technique described in Non-Patent Literature 1 achieves clock synchronization by performing resampling in synchronization with clocks as digital signal processing in a DSP-LSI.

An optical receiver described in Non-Patent Literature 1 performs division and dispersion compensation on subcarriers in a frequency domain, and then dynamically changes a Finite Impulse Response filter (hereinafter, referred to as an FIR filter.) coefficient in a time domain to adjust delay. Thus, a clock frequency difference between a received signal and the optical receiver is compensated for.

### CITATION LIST

### Non-Patent Literature

Non-Patent Literature 1: D. Schmidt and B. Lankl, “Structure of a Digital Feedback Clock Recovery for Parallelized Receivers,” in Advanced Photonics, OSA Technical Digest (CD) (Optical Society of America, 2011), paper SPTuC2.

### SUMMARY OF INVENTION

### Technical Problem

However, the conventional technique described in Non-Patent Literature 1 needs to adjust delay using the FIR filter, and therefore has a problem that a circuit scale of the DSP-LSI increases and power consumption increases.

The present disclosure solves the above problem, and an object of the present disclosure is to provide an optical receiver and an optical reception method that can suppress an increase in power consumption required to clock synchronization with communicating parties.

### Solution to Problem

An optical receiver according to the present disclosure is an optical receiver to receive an optical signal in which a plurality of subcarrier signals have been subjected to frequency division multiplexing, and includes: a coherent detector to coherently detect the optical signal, and convert the optical signal into an electrical signal; an ADC to convert a received signal converted into the electrical signal by the coherent detector into a digital signal; Fourier transform processing circuitry to perform Fourier transform on the received signal converted into the digital signal by the ADC into a signal in a frequency domain; division processing circuitry to divide the signal in the frequency domain converted by the Fourier transform processing circuitry into a signal per frequency band of each of the subcarrier signals; and a plurality pieces of subcarrier demodulation processing circuitry to each demodulate a corresponding one of the subcarrier signals, by multiplying the signal divided by the division processing circuitry with a filter coefficient for compensating for wavelength dispersion and adjusting delay of the optical signal in an optical transmission path, converting the signal multiplied with the filter coefficient into a signal in a time domain, adaptively equalizing the signal in the time domain whose number of samples has been adjusted, compensating for phase shift of the equalized signal, and demapping the signal whose phase shift has been compensated for, the plurality pieces of subcarrier demodulation processing circuitry being each provided per frequency band of each of the subcarrier signals, and the pieces of subcarrier demodulation processing circuitry each include a lookup table in which a plurality of the filter coefficients are stored depending on delay amounts, detect a clock phase of the signal in the time domain whose number of samples has been adjusted, estimate a clock frequency difference from the received signal using a detection value of the clock phase, determine a sampling phase for each Fourier transform depending on an estimation value of the clock frequency difference, select from the lookup table the filter coefficient associated with the delay amount corresponding to the determined sampling phase, and multiply the signal divided by the division processing circuitry with the selected filter coefficient.

### Advantageous Effects of Invention

According to the present disclosure, a clock phase of a signal in a time domain whose number of samples has been adjusted is detected, a clock frequency difference from a received signal is estimated using a detection value of the clock phase, a sampling phase for each Fourier transform is determined depending on an estimation value of the clock frequency difference, a filter coefficient associated with a delay amount corresponding to the sampling phase is selected from a lookup table in which a plurality of filter coefficients for compensating wavelength dispersion and adjusting delay of an optical signal in an optical transmission path are stored, and a signal divided by a division unit is multiplied with the selected filter coefficient. Consequently, the optical receiver according to the present disclosure can suppress an increase in power consumption required to clock synchronization with communicating parties.

### BRIEF DESCRIPTION OF DRAWINGS

FIG. 1 is a block diagram illustrating a configuration example of an optical receiver according to Embodiment 1.

FIG. 2 is a flowchart illustrating an optical reception method according to Embodiment 1.

FIG. 3 is a block diagram illustrating a configuration example of an optical receiver according to Embodiment 2.

FIG. 4 is a block diagram illustrating a hardware configuration that implements the functions of the optical receivers according to Embodiment 1 and Embodiment 2.

FIG. 5 is a block diagram illustrating a hardware configuration that executes software that implements the functions of the optical receivers according to Embodiment 1 and Embodiment 2.

### DESCRIPTION OF EMBODIMENTS

### Embodiment 1

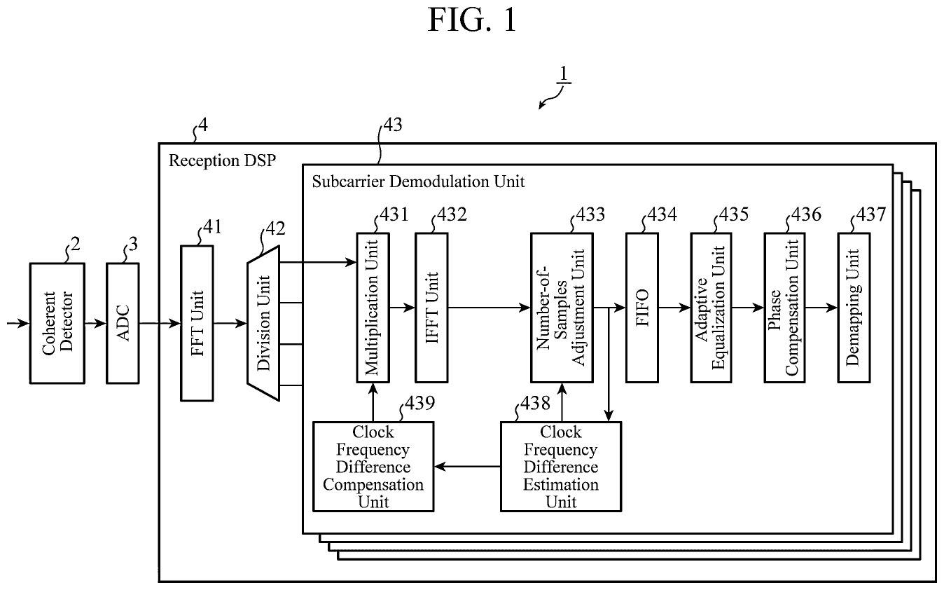

FIG. 1 is a block diagram illustrating a configuration example of an optical receiver 1 according to Embodiment 1. An optical signal received by the optical receiver 1 is obtained by performing frequency division multiplexing on asynchronous optical signals transmitted from a plurality of communicating parties as subcarrier signals. FIG. 1 illustrates a case where the optical receiver 1 can receive an optical signal in which four subcarrier signals at maximum are multiplexed.

As illustrated in FIG. 1, the optical receiver 1 includes a coherent detector 2, an ADC 3, and a reception DPS 4. The reception DSP 4 includes an FFT unit 41, a division unit 42, and a subcarrier demodulation unit 43 for each subcarrier signal. The subcarrier demodulation unit 43 includes a multiplication unit 431, an IFFT unit 432, a number-of-samples adjustment unit 433, an FIFO 434, an adaptive equalization unit 435, a phase compensation unit 436, a demapping unit 437, a clock frequency difference estimation unit 438, and a clock frequency difference compensation unit 439.

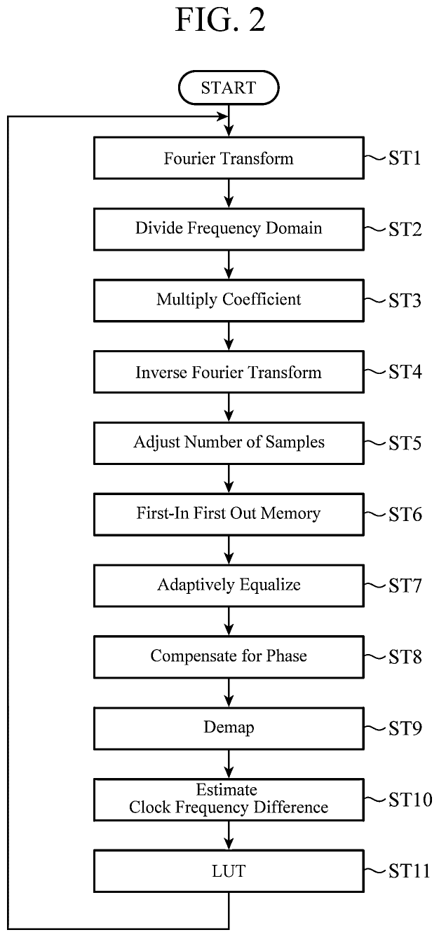

FIG. 2 is a flowchart illustrating an optical reception method according to Embodiment 1, and illustrates an operation of the reception DSP 4 included in the optical receiver 1. First, the coherent detector 2 coherently detects an optical signal received by the optical receiver 1, and converts the optical signal into an electrical signal. The ADC 3 is an analog-to-digital converter that converts the electrical signal coherently detected and acquired by the coherent detector 2 into a digital signal. The digital signal obtained by conversion by the ADC 3 is output to the FFT unit 41 that is a Fourier transform unit.

In the reception DSP 4, the FFT unit 41 performs Fourier transform on the digital signal converted by the ADC 3 into a signal in a frequency domain (step ST1). The division unit 42 divides the signal in the frequency domain converted by the FFT unit 41 into a signal in the frequency domain corresponding to each subcarrier signal (step ST2). The signals divided by the division unit 42 are input to the respective individual subcarrier demodulation units 43.

The multiplication unit 431 multiplies the signal input to the subcarrier demodulation unit 43 with a filter coefficient for compensating for wavelength dispersion and adjusting delay (step ST3). The signal multiplied with the filter coefficient by the multiplication unit 431 is output to the IFFT unit 432 that is an inverse Fourier transform unit. Note that the filter coefficient is output from the clock frequency difference compensation unit 439 to the multiplication unit 431.

The IFFT unit 432 performs inverse Fourier transform on the signal multiplied with the filter coefficient into a signal in a time domain (step ST4). The FFT unit 41 and the IFFT unit 432 perform Fourier transform and inverse Fourier transform on a plurality of samples corresponding to signals in a continuous time. In this regard, the FFT unit 41 and the IFFT unit 432 perform transform by overlapping sections in the time domain to prevent deterioration of signals at a seam of the sections in which Fourier transform and inverse Fourier transform are performed. The IFFT unit 432 eliminates the above overlap portion in the signal subjected to inverse Fourier transform, adds one extra sample to the end of the signal every inverse Fourier transform, and outputs the signal to the number-of-samples adjustment unit 433.

The number-of-samples adjustment unit 433 adjusts the number of samples in accordance with a number-of-samples signal from the clock frequency difference estimation unit 438 (step ST5). The signal whose number of samples is adjusted by the number-of-samples adjustment unit 433 is output to the FIFO 434. The FIFO 434 is a first-in first-out memory, and temporarily stores the signal output by the number-of-samples adjustment unit 433.

The FIFO 434 outputs the signals, output in the stored order to the adaptive equalization unit 435 in response to a request from the adaptive equalization unit 435 (step ST6). Note that, when the number of stored signals decreases, and the FIFO 434 cannot output signals requested from the adaptive equalization unit 435, the FIFO 434 notifies the adaptive equalization unit 435 that the signals cannot be output.

The adaptive equalization unit 435 adaptively equalizes the signal output by the FIFO 434 using an FIR filter that is an equalization filter (step ST7). For example, the adaptive equalization unit 435 updates an adaptive equalization filter coefficient in such a way that a distribution of the signals to be output is close to an ideal signal distribution. Note that a least mean square algorithm or the like is used for update.

The phase compensation unit 436 compensates for phase shift (phase error) of the signal adaptively equalized by the adaptive equalization unit 435 (step ST8). For example, the phase compensation unit 436 performs phase compensation using the Vitervi-Viterbi algorithm described in Reference Literature 1. The demapping unit 437 receives an input of the signal whose phase shift has been compensated for by the phase compensation unit 436, and demaps the input signal (step ST9).

(Reference Literature 1) A. J. Viterbi and A. M. Viterbi, “Nonlinear estimation of PSK-modulated carrier phase with application to burst digital transmission,” Trans. Inf. Theory, Vol. 29, No. 4, pp. 543-551, July 1983.

The clock frequency difference estimation unit 438 detects a clock phase of the signal whose number of samples has been adjusted by the number-of-samples adjustment unit 433. For example, the clock frequency difference estimation unit 438 detects the clock phase of a received signal on the basis of a change in the strength of the received signal using methods described in Reference Literature 2 and Reference Literature 3.

(Reference Literature 2) F. Gardner, “A BPSK/QPSK Timing-Error Detector for Sampled Receivers,” in IEEE Transactions on Communications, vol. 34, no. 5, pp. 423-429, May 1986.

(Reference Literature 3) Meng Yan et al., “Digital clock recovery algorithm for Nyquist signal,” 2013 Optical Fiber Communication Conference and Exposition and the National Fiber Optic Engineers Conference (OFC/NFOEC), paper OTu2I.7, 2013.

Next, the clock frequency difference estimation unit 438 calculates an estimation value of the clock frequency difference, by using a detection value of the clock phase detected from the signal output by the number-of-samples adjustment unit 433 as an estimation value through the low pass filter, and multiplying the estimation value with a negative constant multiple (step ST10). The clock frequency difference estimation unit 438 determines a sampling phase for each Fourier transform depending on the estimation value of the clock frequency difference, and outputs a delay selection signal to the clock frequency difference compensation unit 439. The delay selection signal is a signal that allows selection of a filter coefficient associated with a delay amount corresponding to the sampling phase determined by the clock frequency difference estimation unit 438 from a coefficient LUT.

Note that the coefficient LUT is lookup table information in which a plurality of filter coefficients used to compensate for wavelength dispersion and adjust delay, are stored, and is provided for each subcarrier demodulation unit 43.

When the sampling phase exceeds 2π in a positive direction, the clock frequency difference estimation unit 438 outputs, to the number-of-samples adjustment unit 433, a number-of-samples signal indicating the number of samples that is a number obtained by discarding two samples at the end of the signal from the IFFT unit 432 and decreasing the number of samples by two.

Furthermore, when the sampling phase exceeds 0 in a negative direction, the clock frequency difference estimation unit 438 outputs to the number-of-samples adjustment unit 433 a number-of-samples signal indicating the number of samples that does not change from the number of samples of the signal from the IFFT unit 432.

In another case, the clock frequency difference estimation unit 438 outputs to the number-of-samples adjustment unit 433 a number-of-samples signal indicating the number of samples obtained by discarding one sample at the end of the signal from the IFFT unit 432 and decreasing the number of samples by one.

The clock frequency difference compensation unit 439 compensates for wavelength dispersion in an optical transmission path, and stores in the coefficient LUT a plurality of filter coefficients that cause delay (step ST11). The coefficient LUT stores the plurality of filter coefficients associated with a plurality of delay amounts. The clock frequency difference compensation unit 439 selects a filter coefficient associated with the delay amount selected by the clock frequency difference estimation unit 438 from the coefficient LUT using the delay selection signal, and outputs the filter coefficient to the multiplication unit 431. A filter coefficient H (f) is expressed by the following equation (1). In the following equation (1), f represents the frequency, Ψ represents the sampling phase, j represents an imaginary number unit, D represents wavelength dispersion, λ represents the wavelength of light, c represents the light speed, and fₛ represents the sampling frequency.

$$H ( f ) = exp \{ - j \times ( D / 2 ) \times ( {λ}^{2} / 2 π c ) \times {( 2 π f )}^{2} \} exp \{ j \times ( f / {f}_{s} ) \times φ \} \qquad ( 1 )$$

The filter coefficient H(f) is calculated as a delay amount corresponding to a sampling phase obtained by dividing 0 to 2π into, for example, 16 sections, and is stored in the coefficient LUT. The clock frequency difference estimation unit 438 approximately selects the filter coefficient depending on the delay amount.

As described above, the optical receiver 1 according to Embodiment 1 detects a clock phase of a signal in a time domain whose number of samples has been adjusted, estimates a clock frequency difference from a received signal using a detection value of the clock phase, determines a sampling phase for each FFT depending on an estimation value of the clock frequency difference, selects from the coefficient LUT the filter coefficient associated with a delay amount corresponding to the sampling phase, and multiplies a signal divided by the division unit with the selected filter coefficient.

The optical receiver 1 compensates for the clock frequency difference by dividing subcarrier signals per frequency band and compensating for wavelength dispersion for a signal in the frequency domain obtained by performing FFT on the received signal, adjusting delay at a low speed on the basis of the estimation value of the clock frequency difference, and adjusting remaining delay at a high speed by adaptive equalization. Consequently, the optical receiver 1 can suppress an increase in power consumption required to clock synchronization with communicating parties.

Wavelength dispersion of an optical signal in an optical transmission path is inevitable during optical fiber communication. Hence, conventional optical receivers have required circuits that compensate for wavelength dispersion. By contrast with this, as described above, the optical receiver 1 shares the same filter for compensation for wavelength dispersion and delay adjustment, and consequently does not need an FIR filter for delay adjustment. Furthermore, a large circuit resource is necessary to implement a multiplier on a digital signal processing circuit. Furthermore, the FIR filter needs the multiplier. By contrast with this, the optical receiver 1 does not need a multiplier although the number of filter coefficients to be stored in the coefficient LUT increases. Consequently, the optical receiver 1 makes it possible to reduce the circuit scale.

### Embodiment 2

Although the clock frequency difference estimation unit detects a clock phase of a received signal in the optical receiver according to Embodiment 1, an adaptive equalization unit detects a clock phase in an optical receiver according to Embodiment 2.

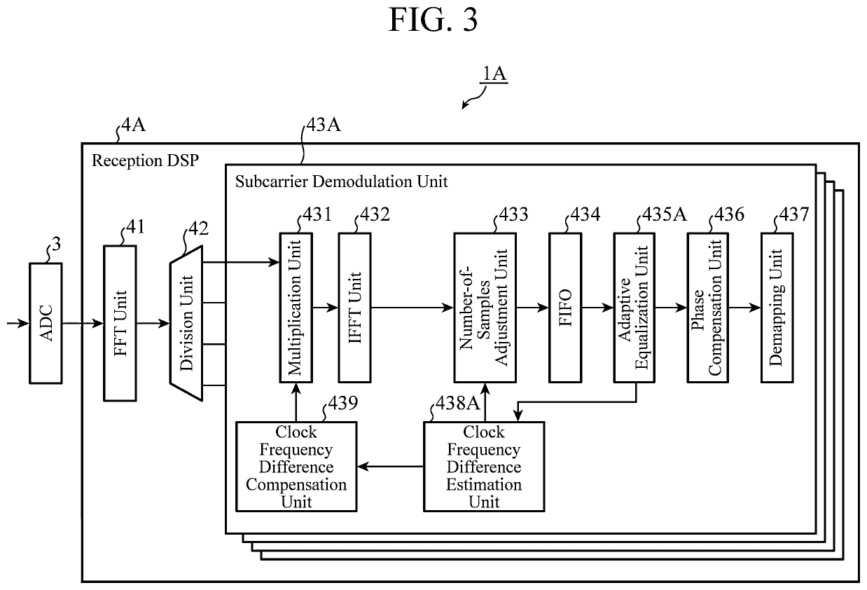

FIG. 3 is a block diagram illustrating a configuration of an optical receiver 1A according to Embodiment 2. In FIG. 3, an optical signal received by the optical receiver 1A is obtained by performing frequency division multiplexing on asynchronous optical signals transmitted from a plurality of communicating parties as subcarrier signals. FIG. 3 illustrates a case where the optical receiver 1A can receive an optical signal in which four subcarrier signals at maximum are multiplexed.

As illustrated in FIG. 3, the optical receiver 1A includes the coherent detector 2, the ADC 3, and a reception DPS 4A. The reception DSP 4A includes the FFT unit 41, the division unit 42, and a subcarrier demodulation unit 43A. The subcarrier demodulation unit 43A includes the multiplication unit 431, the IFFT unit 432, the number-of-samples adjustment unit 433, the FIFO 434, an adaptive equalization unit 435A, the phase compensation unit 436, the demapping unit 437, a clock frequency difference estimation unit 438A, and the clock frequency difference compensation unit 439.

The adaptive equalization unit 435A adaptively equalizes the signal output by the FIFO 434 using the FIR filter similarly to Embodiment 1. Furthermore, the adaptive equalization unit 435A detects a clock phase on the basis of the inclination of phase characteristics in the frequency domain of the FIR filter that is the equalization filter, and outputs the detected clock phase to the clock frequency difference estimation unit 438A. The clock frequency difference estimation unit 438A calculates, as an estimation value of a clock frequency difference, a value obtained by multiplying a detection value of the clock phase detected by the adaptive equalization unit 435A with the negative constant multiple through the low pass filter.

For example, the adaptive equalization unit 435A performs Fourier transform on an adaptive equalization filter coefficient of the FIR filter into a signal in the frequency domain, linearly approximates a change in the frequency of the phase of the signal as the phase characteristics of the signal in the frequency domain, and detects the clock phase of a received signal from a linear inclination that indicates the linearly approximated change. The adaptive equalization unit 435A outputs the detected clock phase to the clock frequency difference estimation unit 438A.

The clock frequency difference estimation unit 438A calculates the estimation value of the clock frequency difference, by using the clock phase detected by the adaptive equalization unit 435A as an estimation value through the low pass filter, and multiplying the estimation value with the negative constant multiple. Furthermore, in a case where the inclination of the clock phase is expressed as Ψ/fₛ with respect to the sampling frequency fₛ, the clock phase is expressed as the sampling phase Ψ.

As described above, in the optical receiver 1A according to Embodiment 2, the adaptive equalization unit 435A detects the clock phase on the basis of the inclination of the phase characteristics in the frequency domain of the FIR filter, and outputs the detected clock phase to the clock frequency difference estimation unit 438A. The clock frequency difference estimation unit 438A calculates, as an estimation value of a clock frequency difference, a value obtained by multiplying a detection value of the clock phase, which is detected by the adaptive equalization unit 435A, with the negative constant multiple through the low pass filter.

Similarly to Embodiment 1, the optical receiver 1A does not need the FIR filter for delay adjustment. Furthermore, the optical receiver 1A detects the clock phase of the received signal on the basis of the adaptive equalization filter coefficient of the FIR filter of the adaptive equalization unit 435A, and consequently does not need a clock phase detection circuit in the clock frequency difference estimation unit 438A.

Note that the filter length of the FIR filter in the adaptive equalization unit 435A is approximately 20, and a circuit for performing Fourier transform and linear approximation for detecting the clock phase is sufficiently small, so that it is possible to reduce the circuit scale necessary for detection of the clock phase.

Next, a hardware configuration that implements the functions of the optical receivers 1 and 1A according to Embodiment 1 and Embodiment 2 will be described.

The functions of the reception DSPs 4 and 4A included in the optical receivers 1 and 1A are implemented by a processing circuit. That is, the optical receivers 1 and 1A include the processing circuit for executing processing in steps ST1 to ST11 illustrated in FIG. 2. The processing circuit may be dedicated hardware, yet may be a Central Processing Unit (CPU) that executes programs stored in a memory.

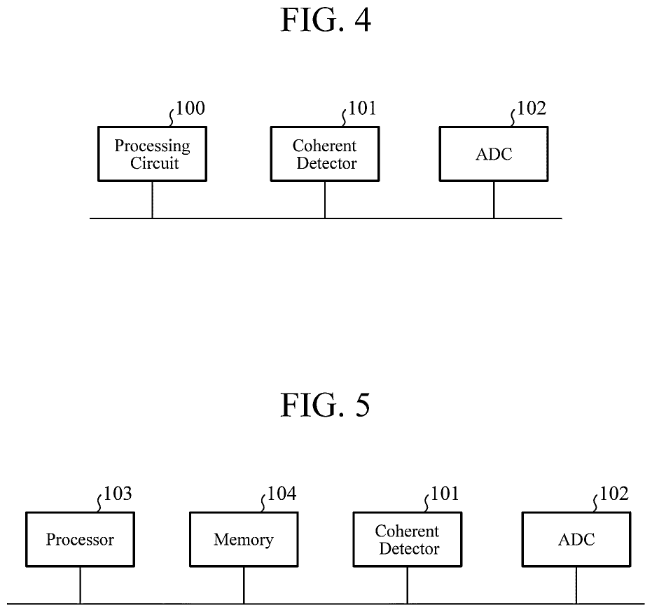

FIG. 4 is a block diagram illustrating the hardware configuration that implements the functions of the optical receivers 1 and 1A. FIG. 5 is a block diagram illustrating a hardware configuration that executes software that implements the functions of the optical receivers 1 and 1A. In FIGS. 4 and 5, a coherent detector 101 is the coherent detector 2 illustrated in FIGS. 1 and 3. An ADC 102 is the ADC 3 illustrated in FIGS. 1 and 3.

In a case where the above processing circuit is a processing circuit 100 of the dedicated hardware illustrated in FIG. 4, the processing circuit 100 corresponds to, for example, a single circuit, a composite circuit, a programmed processor, a parallel-programmed processor, an Application Specific Integrated Circuit (ASIC), a Field-Programmable Gate Array (FPGA), or a combination thereof. The functions of the FFT unit, the division unit, and the subcarrier demodulation unit included in the optical receivers 1 and 1A may be implemented as different processing circuits, and these functions may be implemented collectively by one processing circuit.

In a case where the above processing circuit is a processor 103 illustrated in FIG. 5, the functions of the FFT unit, the division unit, and the subcarrier demodulation unit included in the optical receivers 1 and 1A are implemented by software, firmware, or a combination of software and firmware. Note that the software or the firmware is described as programs, and stored in a memory 104.

The processor 103 implements the functions of the FFT unit, the division unit, and the subcarrier demodulation unit by reading and executing the programs stored in the memory 104. For example, the FFT unit, the division unit, and the subcarrier demodulation unit included in the optical receivers 1 and 1A include the memory 104 for storing the programs for eventually executing the processing in steps ST1 to ST11 illustrated in FIG. 2 when the processor 103 executes the programs.

These programs cause a computer to execute a processing procedure or method performed by the FFT unit, the division unit, and the subcarrier demodulation unit included in the optical receivers 1 and 1A. The memory 104 may be a computer-readable storage medium having recorded thereon the programs for causing the computer to function as the FFT unit, the division unit, and the subcarrier demodulation unit.

The memory 104 corresponds to, for example, a non-volatile or volatile semiconductor memory such as a Random Access Memory (RAM), a Read Only Memory (ROM), a flash memory, an Erasable Programmable Read Only Memory (EPROM), or an Electrically-EPROM (EEPROM), a magnetic disk, a flexible disk, an optical disk, a compact disk, a mini disk, a DVD, or the like.

Part of the functions of the FFT unit, the division unit, and the subcarrier demodulation unit included in the optical receivers 1 and 1A may be implemented as dedicated hardware, and part of the functions may be implemented by software or firmware. For example, the functions of the FFT unit and the division unit may be implemented by the processing circuit 102 that is the dedicated hardware, and the function of the subcarrier demodulation unit may be implemented by the processor 103 by reading and executing the programs stored in the memory 104. Thus, the processing circuit can implement the above functions by hardware, software, firmware, or a combination thereof.

Note that the embodiments can be combined, any components in the embodiments can be modified, or any components in the embodiments can be omitted.

### INDUSTRIAL APPLICABILITY

The optical receiver according to the present disclosure can be used for optical communication of a digital coherent system, for example.

### REFERENCE SIGNS LIST

1, 1A: optical receiver. 2, 101: coherent detector. 3, 102: ADC. 4, 4A: reception DSP. 41: FFT unit. 42: division unit. 43, 43A: subcarrier demodulation unit. 100: processing circuit. 101: coherent detector. 103: processor. 104: memory. 431: multiplication unit. 432: IFFT unit. 433: number-of-samples adjustment unit. 435, 435A: adaptive equalization unit. 436: phase compensation unit. 437: demapping unit. 438, 438A: clock frequency difference estimation unit. 439: clock frequency difference compensation unit

1. An optical receiver to receive an optical signal in which a plurality of subcarrier signals have been subjected to frequency division multiplexing, the optical receiver comprising:
a coherent detector to coherently detect the optical signal, and convert the optical signal into an electrical signal;
an analog-digital converter to convert a received signal converted into the electrical signal by the coherent detector into a digital signal;
Fourier transform processing circuitry to perform Fourier transform on the received signal converted into the digital signal by the analog-to-digital converter into a signal in a frequency domain;
division processing circuitry to divide the signal in the frequency domain converted by the Fourier transform processing circuitry into a signal per frequency band of each of the subcarrier signals; and
a plurality pieces of subcarrier demodulation processing circuitry to each demodulate a corresponding one of the subcarrier signals, by multiplying the signal divided by the division processing circuitry with a filter coefficient for compensating for wavelength dispersion and adjusting delay of the optical signal in an optical transmission path, converting the signal multiplied with the filter coefficient into a signal in a time domain, adaptively equalizing the signal in the time domain whose number of samples has been adjusted, compensating for phase shift of the equalized signal, and demapping the signal whose phase shift has been compensated for, the plurality pieces of subcarrier demodulation processing circuitry being each provided per frequency band of each of the subcarrier signals,
wherein the pieces of subcarrier demodulation processing circuitry each
include a lookup table in which a plurality of the filter coefficients are stored depending on delay amounts,
detect a clock phase of the signal in the time domain whose number of samples has been adjusted,
estimate a clock frequency difference from the received signal using a detection value of the clock phase, and
determine a sampling phase for each Fourier transform depending on an estimation value of the clock frequency difference, select from the lookup table the filter coefficient associated with the delay amount corresponding to the determined sampling phase, and multiply the signal divided by the division processing circuitry with the selected filter coefficient.

2. The optical receiver according to claim 1, wherein the pieces of subcarrier demodulation processing circuitry each include:
multiplication processing circuitry to multiply the signal divided by the division processing circuitry with the filter coefficient,
inverse Fourier transform processing circuitry to perform inverse Fourier transform on the signal multiplied with the filter coefficient into the signal in the time domain, add one extra sample to an end of the signal every inverse Fourier transform, and output the signal,
number-of-samples adjustment processing circuitry to adjust the number of samples of the signal in the time domain on a basis of a number-of-samples signal,
a first-in first-out memory to store the signal whose number of samples has been adjusted,
adaptive equalization processing circuitry to adaptively equalize the signal output from the first-in first-out memory in such a way that the signal is close to an ideal signal point distribution,
phase compensation processing circuitry to compensate for the phase shift of the equalized signal,
demapping processing circuitry to demap the signal whose phase shift has been compensated for,
clock frequency difference estimation processing circuitry to estimate the clock frequency difference from the received signal, determine the sampling phase corresponding to the clock frequency difference every Fourier transform, and select the filter coefficient associated with the delay amount corresponding to the sampling phase, and
clock frequency difference compensation processing circuitry to read from the lookup table the filter coefficient selected by the clock frequency difference estimation processing circuitry, and output the filter coefficient to the multiplication processing circuitry.

3. The optical receiver according to claim 2, wherein the clock frequency difference estimation processing circuitry detects a clock phase of a signal output from the number-of-samples adjustment processing circuitry, and calculates, as an estimation value of the clock frequency difference, a value obtained by multiplying a detection value of the clock phase with a negative constant multiple through a low pass filter.

4. The optical receiver according to claim 3, wherein
the number-of-samples adjustment processing circuitry adjusts the number of samples of the signal in the time domain converted by the inverse Fourier transform processing circuitry in accordance with the number-of-samples signal output from the clock frequency difference estimation processing circuitry, and
the clock frequency difference estimation processing circuitry
outputs to the number-of-samples adjustment processing circuitry a number-of-samples signal for instructing to discard two samples at the end of the signal in the time domain converted by the inverse Fourier transform processing circuitry and decrease the number of samples by two when the determined sampling phase exceeds 2π in a positive direction,
outputs to the number-of-samples adjustment processing circuitry a number-of-samples signal for instructing not to change the number of samples of the signal in the time domain converted by the inverse Fourier transform processing circuitry when the determined sampling phase exceeds 0 in a negative direction, and
outputs to the number-of-samples adjustment processing circuitry a number-of-samples signal for instructing to discard one sample at the end of the signal in the time domain converted by the inverse Fourier transform processing circuitry and decrease the number of samples by one when the determined sampling phase does not exceed 2π in the positive direction, and does not exceed 0 in the negative direction.

5. The optical receiver according to claim 3, wherein
the adaptive equalization processing circuitry detects a clock phase on a basis of an inclination of phase characteristics in the frequency domain of an equalization filter, and outputs the detected clock phase to the clock frequency difference estimation processing circuitry, and
the clock frequency difference estimation processing circuitry calculates, as the estimation value of the clock frequency difference, a value obtained by multiplying the detection value of the clock phase detected by the adaptive equalization processing circuitry with the negative constant multiple through the low pass filter.

6. An optical reception method of an optical receiver to receive an optical signal in which a plurality of subcarrier signals have been subjected to frequency division multiplexing, comprising:
coherently detecting the optical signal, and converting the optical signal into an electrical signal;
converting a received signal converted into the electrical signal into a digital signal;
performing Fourier transform on the received signal converted into the digital signal into a signal in a frequency domain; and
dividing the signal in the frequency domain converted into a signal per frequency band of each of the subcarrier signals,
the optical reception method further comprising:
multiplying the signal divided with a filter coefficient for compensating for wavelength dispersion and adjusting delay of the optical signal in an optical transmission path;
performing inverse Fourier transform on the signal multiplied with the filter coefficient into a signal in a time domain, adding one extra sample to an end of the signal every inverse Fourier transform, and outputting the signal;
adjusting a number of samples of the signal in the time domain on a basis of a number-of-samples signal;
storing the signal whose number of samples has been adjusted;
adaptively equalizing the signal output from the first-in first-out memory in such a way that the signal is close to an ideal signal point distribution;
compensating for phase shift of the equalized signal;
demapping the signal whose phase shift has been compensated for;
estimating a clock frequency difference from the received signal, determining a sampling phase corresponding to the clock frequency difference every Fourier transform, and selecting the filter coefficient associated with the delay amount corresponding to the sampling phase; and
reading the filter coefficient selected from a lookup table in which a plurality of the filter coefficients are stored depending on delay amounts, and outputting the filter coefficient.
